(19) United States
(12) Patent Application Publication
(10) Pub. No.: US 2022/0193532 A1
(43) Pub. Date: Jun. 23, 2022

(54) COMPOSITE CARD SHUFFLING APPARATUS

(71) Applicant: Boller Technology Co., Ltd., Hsinchu City (TW)

(72) Inventor: HO-TIEN TENG, Hsinchu City (TW)

(21) Appl. No.: 17/177,366

(22) Filed: Feb. 17, 2021

(30) Foreign Application Priority Data
Dec. 23, 2020 (TW) 109145613

(51) Int. Cl. A63F 1/12; G06F 7/58

(52) U.S. Cl. CPC A63F 1/12; G06F 7/588

(57) ABSTRACT

A composite card shuffling apparatus comprises a card input assembly that has a card input housing configured to accommodate cards, and a card input guiding device configured to move the cards out from the card input housing sequentially; a card slot rotating assembly that has a main body having card slots, and a rotating device configured to rotate the main body, so that the card slots respectively receive the cards from the card input housing; a card output assembly that has a card output housing, a card output driving device configured to move the cards from the slots respectively into the card output housing, and a transporting device configured to transport the cards inside the card output housing to the outside of the card output housing; and a card picking platform that has a card picking opening for receiving the cards transported by the transporting device.

### CROSS-REFERENCE TO RELATED APPLICATION

This application claims the priority benefit of Taiwan patent application serial no. 10/914,5613, filed on Dec. 23, 2020, the entirety of which is incorporated by reference herein.

### FIELD

The present disclosure relates to a card shuffling apparatus, and particularly relates to a composite card shuffling apparatus.

### BACKGROUND

At present, some casinos or entertainment places have provided automatic card shuffling apparatuses for shuffling game cards (such as playing cards) so as to save manpower and avoid cheating caused by human factors at the same time. However, the card shuffling apparatuses manufactured by different manufacturers have a variety of different structural designs according to customer needs, resulting in higher design cost. Therefore, it is necessary to design a composite card shuffling apparatus to provide composite functions and reduce the structural design cost.

### SUMMARY

An embodiment of the present disclosure provides a composite card shuffling apparatus comprising a card input assembly, a card slot rotating assembly, a card output assembly and a card picking platform. The card input assembly has a card input housing and a card input guiding device, the card input housing is configured to accommodate a plurality of cards, and the card input guiding device is configured to sequentially move out the plurality of cards from the card input housing. The card slot rotating assembly has a main body and a rotating device, the main body has a plurality of card slots, and the rotating device is configured to rotate the main body, so that the plurality of card slots of the main body respectively receive the plurality of cards moved out from the card input housing. The card output assembly has a card output housing, a card output driving device and a transporting device. The card output driving device is configured to respectively move each of the plurality of cards from the plurality of card slots into the card output housing, and the transporting device is configured to transport the plurality of cards inside the card output housing to the outside of the card output housing. The card picking platform has a card picking opening for receiving the plurality of cards transported by the transporting device.

Another embodiment of the present disclosure provides a composite card shuffling apparatus comprising a first card input assembly, a first card slot rotating assembly, a first card output assembly, a second card input assembly, a second card slot rotating assembly, a second card output assembly and a rotary alignment assembly. The first card input assembly has a first card input housing and a first card input guiding device, the first card input housing is configured to accommodate a first set of cards, and the first card input guiding device is configured to sequentially move out the first set of cards from the first card input housing; the first card slot rotating assembly has a first main body and a first rotating device, the first main body has a plurality of card slots defined thereon, and the first rotating device is connected to the first main body for rotating the first main body, so that the plurality of card slots of the first main body respectively receive the first set of cards sequentially moved out from the first card input housing; the first card output assembly has a first card output housing and a first card output driving device, the first card output driving device is configured to respectively move each of the first set of cards from the plurality of card slots into the first card output housing; the second card input assembly is disposed with the first card input assembly side by side and has a second card input housing and a second card input guiding device, wherein the second card input housing is configured to accommodate a second set of cards, and the second card input guiding device is configured to sequentially move out the second set of cards from the second card input housing; the second card slot rotating assembly is disposed with the first card slot rotating assembly side by side and has a second main body and a second rotating device, wherein the second main body has a plurality of card slots defined thereon, and the second rotating device is connected to the second main body for rotating the second main body, so that the plurality of card slots of the second main body respectively receive the second set of cards sequentially moved out from the second card input housing; the second card output assembly is disposed with the first card output assembly side by side and has a second card output housing and a second card output driving device, wherein the second card output driving device is configured to respectively move each of the second set of cards from the plurality of card slots into the second card output housing; and the rotary alignment assembly has a first rotating arm, a second rotating arm and a transporting carrier, wherein after the first set of cards enter the first card output housing, and the second set of cards enter the second card output housing, the first rotating arm and the second rotating arm respectively rotate by a predetermined degrees, so that the first card output housing and the second card output housing are aligned along a straight line; and wherein after the first card output housing and the second card output housing are aligned, the transporting carrier pushes upward along the straight line from a position below the bottom of the first and the second card output housings, so that the first set of cards and the second set of cards are stacked and pushed to a card picking opening.

A further embodiment of the present disclosure provides a composite card shuffling apparatus comprising a first card input assembly, a second card input assembly, a card slot rotating assembly, a first card output assembly, a second card output assembly and a sliding assembly. The first card input assembly has a first card input housing and a first card input guiding device, the first card input housing is configured to accommodate a first set of cards, and the first card input guiding device is configured to sequentially move out the first set of cards from the first card input housing; the second card input assembly is disposed with the first card input assembly side by side and has a second card input housing and a second card input guiding device, the second card input housing is configured to accommodate a second set of cards, and the second card input guiding device is configured to sequentially move out each of the second set of cards from the second card input housing; the card slot rotating assembly has a main body and a rotating device, the main body has a plurality of card slots defined thereon, and the rotating device is connected to the main body for rotating the main body, so that the plurality of card slots of the main body respectively receive the first set of cards sequentially moved out from the first card input housing or receive the second set of cards sequentially moved out from the second card input housing; the first card output assembly has a first card output housing and a first card output driving device, and the first card output driving device is configured to respectively move each of the first set of cards from the plurality of card slots into the first card output housing; the second card output assembly is disposed with the first card output assembly side by side and has a second card output housing and a second card output driving device, wherein the second card output driving device is configured to respectively move each of the second set of cards from the plurality of card slots into the second card output housing; and the sliding assembly is disposed at a bottom of the card slot rotating assembly, wherein the sliding assembly is configured to slide the card slot rotating assembly to a position between the first card input assembly and the first card output assembly or between the second card input assembly and the second card output assembly.

The composite card shuffling apparatus provided in the present disclosure provides a variety of different configurations according to customer needs, and examples will be described below.

### BRIEF DESCRIPTION OF THE DRAWINGS

In order to make the above and other objectives, features, advantages and embodiments of the present disclosure more comprehensible, the description of the accompanying drawings is as follows:

FIG. 1 is a perspective schematic diagram of a composite card shuffling apparatus according to an embodiment of the present disclosure.

FIG. 2 is an exploded schematic diagram of the composite card shuffling apparatus shown in FIG. 1.

FIG. 3 is a schematic circuit block diagram of a smart control device according to an embodiment of the disclosure.

FIG. 4 is an exploded schematic diagram of a portion of the card input assembly shown in FIG. 2.

FIG. 5A is a schematic diagram showing a partial cross section of a card input assembly and a side view of a card slot rotating assembly as shown in FIG. 2.

FIG. 5B shows another embodiment of the card input assembly shown in FIG. 5A.

FIG. 5C is a partial enlarged view of a main body of the card slot rotating assembly shown in FIG. 2 according to one embodiment of the present disclosure.

FIG. 5D is a partial enlarged view of the card slot shown in FIG. 5C with a card held thereinside.

FIG. 5E is a partial enlarged view of a main body of the card slot rotating assembly shown in FIG. 2 according to another embodiment of the present disclosure.

FIG. 5F is a partial enlarged view of the card slot shown in FIG. 5E with a card held thereinside.

FIG. 6 is an exploded schematic diagram showing the card slot rotating assembly and a portion of a card output driving device of the card output assembly as shown in FIG. 2.

FIG. 7 is a schematic diagram showing a longitudinal cross section of portions of the card slot rotating assembly and the card output assembly shown in FIG. 2.

FIG. 8 is a schematic diagram showing a transverse cross section of portions of the card slot rotating assembly and the card output driving device of the card output assembly as shown in FIG. 2.

FIG. 9 is an exploded schematic diagram of a portion of the card output assembly shown in FIG. 2.

FIG. 10 is a schematic diagram of a composite card shuffling apparatus according to another embodiment of the present disclosure.

FIG. 11a is a perspective schematic diagram of an automatic card clamping and rotating assembly shown in FIG. 10.

FIG. 11b is a perspective schematic diagram showing another side of the card clamping body shown in FIG. lla.

FIG. 11c is a schematic diagram showing two lifting devices configured to drive a first driving slider shown in FIG. 1 la and a second driving slider shown in FIG. 1 lb according to an embodiment of the present disclosure.

FIG. 12 is a schematic diagram showing a cross section of portions of the card output assembly and the card picking platform as shown in FIG. 2.

FIG. 13 is a perspective schematic diagram of a composite card shuffling apparatus according to another embodiment of the present disclosure.

FIG. 14a is a schematic diagram of a rotary alignment assembly applicable to the composite card shuffling apparatus shown in FIG.13.

FIG. 14b is a schematic diagram of a first rotating arm and a second rotating arm of the rotary alignment assembly shown in FIG. 14a rotated by 90 degrees.

### DETAILED DESCRIPTION OF THE PREFERRED EMBODIMENTS

The following disclosure provides a number of different embodiments to implement different features of the present invention. Specific examples of elements and arrangements are described below to simplify the disclosure. Of course, these examples are only illustrative and not restrictive. In addition, the present disclosure can repeat element symbols and/or letters in each example. The repetition is just for the purposes of conciseness and clarity, and does not in itself indicate the relationship between the various embodiments and/or configurations discussed.

In this disclosure, unless the article is specifically limited in the context, “a” and “the” can generally refer to one or more. It will be further understood that the terms “include”, “comprise”, “have” and similar words used in this disclosure indicate the features, elements and/or components described therein, but do not exclude one or more additional features, elements, components, and/or their groups described thereof.

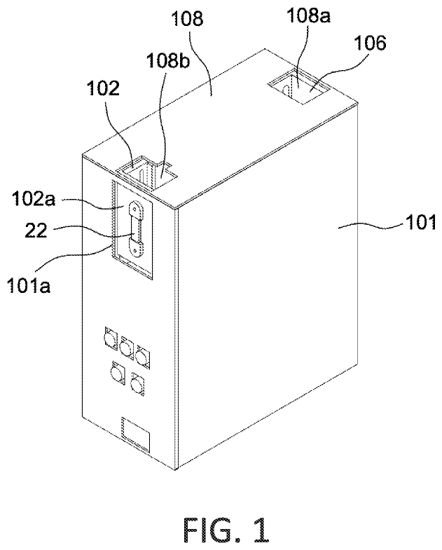

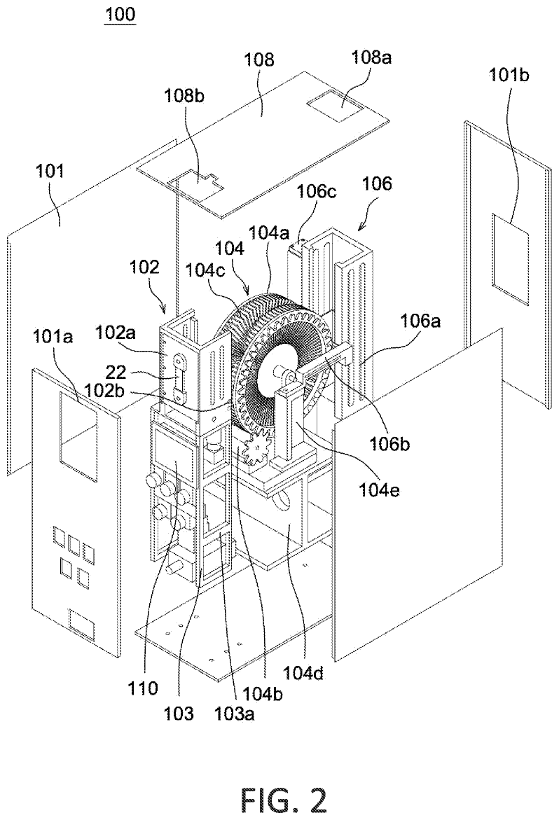

FIG. 1 and FIG. 2 are perspective schematic diagram and exploded schematic diagram respectively showing a composite card shuffling apparatus 100 according to an embodiment of the present disclosure. Referring to FIG. 1 and FIG. 2, the composite card shuffling apparatus 100 can be used to shuffle a plurality of cards. In this embodiment, the plurality of cards can be a plurality of playing cards or any other game cards, and the number of cards is determined according to the game rules of the playing cards or other game cards.

The composite card shuffling apparatus 100 includes a housing 101, a card input assembly 102, a card slot rotating assembly 104, a card output assembly 106, a card picking platform 108 and a smart control device 110. The card input assembly 102, the card slot rotating assembly 104 and the card output assembly 106 are disposed inside the housing 101, and the card slot rotating assembly 104 is disposed between the card input assembly 102 and the card output assembly 106. The card picking platform 108 is disposed above the card input assembly 102, the card slot rotating assembly 104 and the card output assembly 106.

The card input assembly 102 has a card input housing 102a and a card input guiding device 102b. The card input housing 102a is configured to accommodate the plurality of cards, and the card input guiding device 102b is configured to sequentially move out the plurality of cards from the card input housing 102a.

The card slot rotating assembly 104 has a main body 104a and a rotating device 104b. In this embodiment, the main body 104a has a wheel shape, but it is not limited thereto. The main body 104a has a plurality of card slots 104c evenly defined therearound, and each card slot 104c can accommodate and hold a card. In this embodiment, the main body 104a has a total of 104 card slots 104c defined therein for accommodating and holding at most 104 cards of two decks of playing cards. The rotating device 104b is connected to the main body 104a for rotating the main body 104a intermittently, so that the plurality of card slots 104c of the main body 104a respectively receive the plurality of cards sequentially moved out from the card input housing 102a.

The card output assembly 106 has a card output housing 106a, a card output driving device 106b and a transporting device 106c. The card output driving device 106b is configured to respectively move each of the plurality of cards from the plurality of card slots 104c into the card output housing 106a. When the plurality of cards are all moved to the card output housing 106a, they will be stacked into a stack of cards. Subsequently, the transporting device 106c is configured to transport the plurality of cards inside the card output housing 106a to the outside of the card output housing 106a.

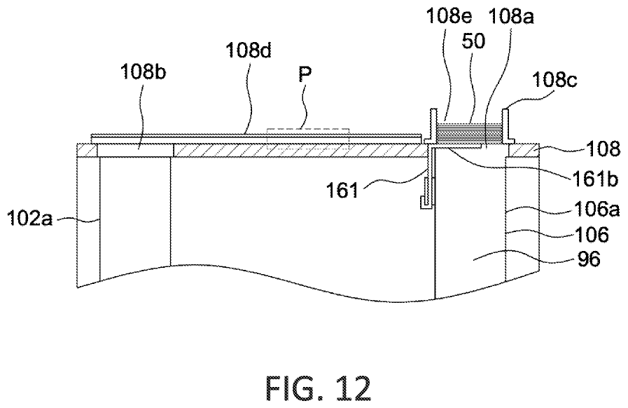

Referring to FIG. 12, the card picking platform 108 has a card picking opening 108a, a card shuffling opening 108b, a moving device 108c and a slide rail 108d. The card picking opening 108a communicates with the card output housing 106a for receiving the plurality of cards transported by the transporting device 106c. The card shuffling opening 108b communicates with the card input housing 102a, so that the plurality of cards can be moved into the card input housing 102a from the card shuffling opening 108b, so as to restart a shuffling process. The moving device 108c is slidably connected to the slide rail 108d and configured to move the plurality of cards 50, which are received from the card picking opening 108a, along the slide rail 108d to a card picking position P on the card picking platform 108, so that the plurality of cards 50 can be taken by a robot arm or a player so as to proceed with a card game. After the card game is over, the moving device 108c is further configured to move the plurality of cards 50 from the card picking position P to the card shuffling opening 108b along the slide rail 108d, so that the plurality of cards 50 can be moved into the card input housing 102a from the card shuffling opening 108b, so as to restart a shuffling process.

In this embodiment, the composite card shuffling apparatus 100 further includes a supporting frame 103. The supporting frame 103 is disposed under the card input housing 102a, and is formed by connecting a plurality of connecting rods 103a for supporting the card input housing 102a. The supporting frame 103 defines a plurality of accommodating spaces by the connecting rods 103a, which are used to accommodate various electronic devices or mechanical components in the composite card shuffling apparatus 100, such as a control panel, a display and a microcomputer host or other devices.

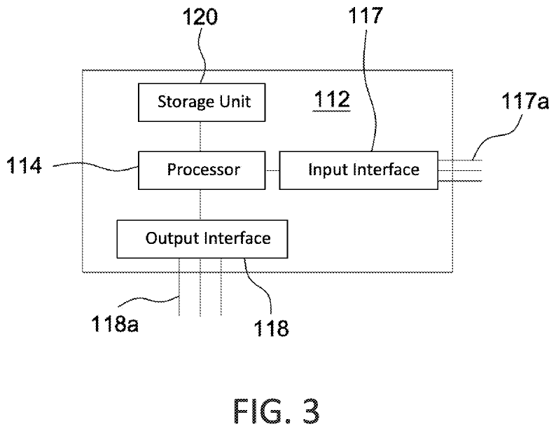

FIG. 3 is a schematic circuit block diagram of a smart control device 110 according to an embodiment of the present disclosure. The smart control device 110 includes a control circuit 112, and the control circuit 112 has a processor 114, an input interface 117, an output interface 118 and a storage unit 120. In this embodiment, the smart control device 110 can be implemented by a microcomputer host and installed in the supporting frame 103. In other embodiments, the smart control device 110 is disposed at any position in the housing 101 of the composite card shuffling apparatus 100 or is disposed outside the housing 101.

The processor 114 generates a variety of different control signals, and transmit the control signals to various electronic devices of the composite card shuffling apparatus 100 through the output lines 118a of the output interface 118 to control and drive the electronic devices. For example, the processor 114 of the control circuit 112 respectively transmits the control signals to the card input guiding device 102b of the card input assembly 102, the rotating device 104b of the card slot rotating assembly 104, the card output driving device 106b and the transporting device 106c of the card output assembly 106 and the moving device 108c of the card picking platform 108 through the output lines 118a of the output interface 118, so as to control and drive the devices. In other embodiment, the control circuit 112 further controls and drives a robot arm for picking up the cards. The method for the processor 114 to control various electronic devices of the composite card shuffling apparatus 100 will be discussed as below.

In this embodiment, the processor 114 generates a first control signal and transmits the first control signal to the card input guiding device102b of the card input assembly 102 through the output lines 118a of the output interface 118, so as to control the card input guiding device 102b to sequentially move out each of the plurality of cards from the card input housing 102a into each of the card slots 104c of the main body 104a of the card slot rotating assembly 104.

Referring to FIG. 2 and FIG. 3, the storage unit 120 is configured to store a random number generating program. The processor 114 is electrically connected to the storage unit 120 and configured to execute the random number generating program to generate a plurality of random numbers. The processor 114 generates at least one second control signal according to the plurality of random numbers and transmits the at least one second control signal to the rotating device 104b of the card slot rotating assembly 104 through the output lines 118a of the output interface 118, so as to control the rotating device 104b to rotate the main body 104a, so that the plurality of card slots 104c of the main body 104a respectively receives the plurality of cards sequentially moved out from the card input housing 102a. In this embodiment, the rotating device 104b intermittently rotates the main body 104a in a clockwise direction or a counterclockwise direction according to the second control signals corresponding to the plurality of random numbers, so that the plurality of cards sequentially moved out from the card input housing 102a are randomly and respectively received by and placed in different card slots 104c. For example, if the plurality of card slots are sequentially numbered from 1 to 104, and the rotating device 104b intermittently and randomly rotates the main body 104a in a clockwise direction according to the second control signals corresponding to the plurality of random numbers, then the first rotation of the main body 104a receives a first card by the No. 1 card slot 104c, the second rotation of the main body 104a receives a second card by the No. 3 card slot 104c, the third rotation of the main body 104a receives a third card by the No. 7 card slot 104c, the fourth rotation of the main body 104a receives a fourth card by the No. 8 card slot 104c, and so on.

In another embodiment, the rotating device 104b intermittently and alternately rotates the main body 104a in a clockwise direction and a counterclockwise direction according to the second control signals, so that the plurality of cards sequentially moved out from the card input housing 102a are randomly and respectively received by and placed in different card slots 104c. For example, the first rotation of the main body 104a receives a first card by the No. 2 card slot 104c, the second rotation of the main body 104a receives a second card by the No. 102 card slot 104c, the third rotation of the main body 104a receives a third card by the No. 1 card slot 104c, the fourth rotation of the main body 104a receives a fourth card by the No. 104 card slot 104c, and so on.

In the two embodiments described above, no matter whether the rotating device 104b intermittently rotates the main body 104a in a single direction (e.g., a clockwise direction or a counterclockwise direction) or intermittently and alternately rotates the main body 104a in a first direction (e.g., a clockwise direction) and a second direction (e.g., a counterclockwise direction) opposite to the first direction, the rotation distance of each rotation of the main body 104a should be as short as possible, so that the plurality of card slots 104c quickly and randomly receive the plurality of cards, so as to save the time for shuffling the cards.

When all or part of the plurality of cards are received by the plurality of card slots 104c, the processor 114 generates a third control signal, which is transmitted to the card output driving device 106b of the card output assembly 106 through the output lines 118a of the output interface 118 for controlling the card output driving device 106b to randomly and respectively move each of the plurality of cards from the plurality of card slots 104c to the card output housing 106a during the intermittent rotation of the main body 104a (such as during the rotation in a single direction or the rotation in two alternative directions as mentioned above), so that the plurality of cards are stacked one by one in the card output housing 106a.

When the plurality of cards are all moved from the card input housing 102a to the card output housing 106a through the card slot rotating assembly 104, the processor 114 generates a fourth control signal to stop the rotating device104b from rotating. Then, the processor 114 generates a fifth control signal and transmit the fifth control signal to the transporting device 106c of the card output assembly 106 through the output lines 118a of the output interface 118 for controlling the transporting device 106c to transport the plurality of stacked cards inside the card output housing 106a to the outside of the card output housing106a (that is, the plurality of cards are pushed out from the card picking opening 108a to the card picking platform 108), so that a shuffling process is completed.

Hereinafter, specific implementations of the card input assembly 102, the card slot rotating assembly 104, the card output assembly 106 and the card picking platform 108 will be illustrated for examples below.

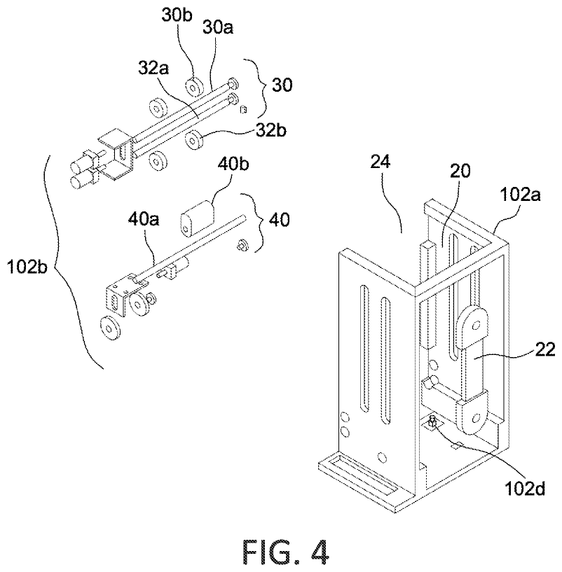

FIG. 4 is an exploded schematic diagram of a portion of the card input assembly 102 shown in FIG. 2. Referring to FIG. 2 and FIG. 4, the card input housing 102a of the card input assembly 102 defines a card accommodating cavity 20, and an outer surface (shown as transparent in FIG.4) of the card input housing 102a is provided with a handle 22 for an operator to pull the card input housing 102a out of an opening 101a of the composite card shuffling apparatus 100 and to place the plurality of cards into the card accommodating cavity 20. In addition, the card input housing 102a has an opening 24 on the other side opposite to the handle 22, and the opening 24 faces and is aligned with at least one of the card slots 104c of the main body 104a of the card slot rotating assembly 104.

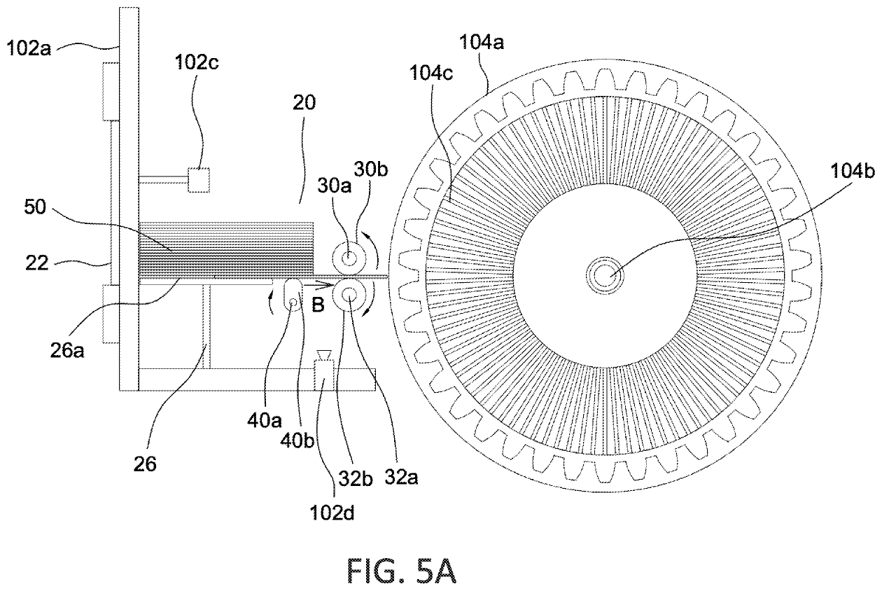

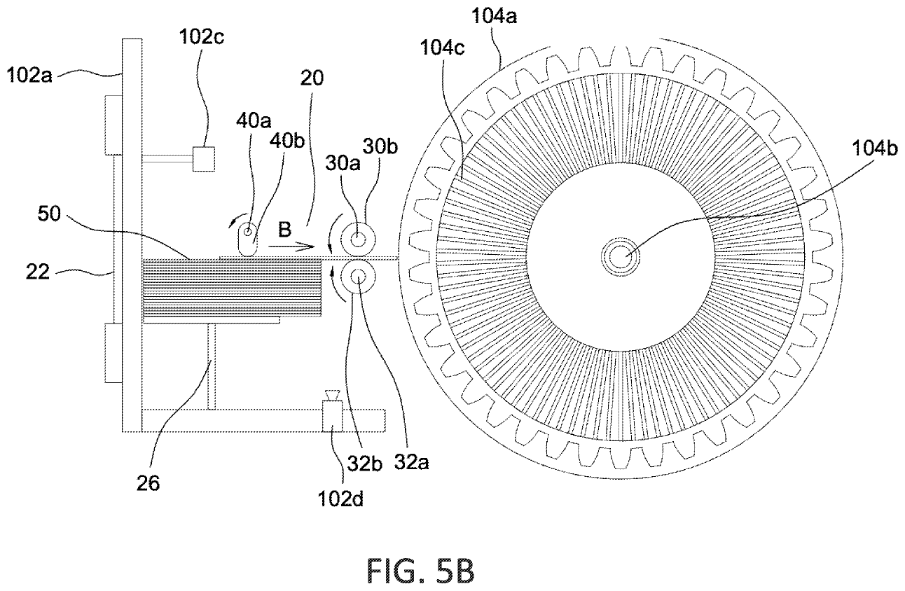

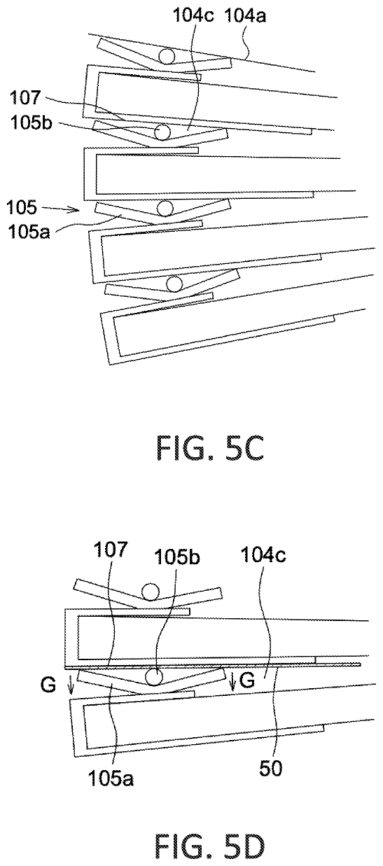

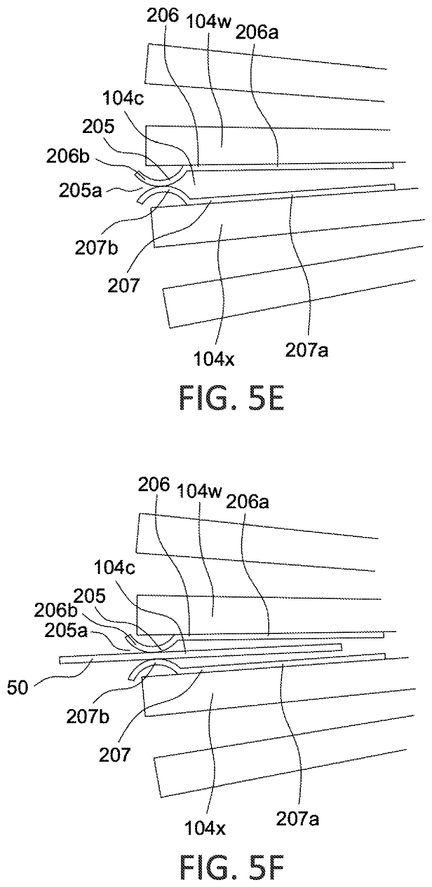

FIG. 5A is a schematic diagram showing a partial cross section of the card input assembly 102 and a side view of the card slot rotating assembly 104 as shown in FIG. 2. Referring to FIGS. 2, 4 and 5A, the card input guiding device 102b of the card input assembly 102 is disposed in the card accommodating cavity 20 for pushing out the plurality of cards 50 placed in the card accommodating cavity 20 and guiding them one by one to the plurality of card slots 104c of the main body 104a of the card slot rotating assembly 104. The card input guiding device 102b has a rolling and clamping member 30 and a pushing member 40. The rolling and clamping member 30 has two rotating shafts 30a, 32a and two pairs of rollers 30b, 32b. The pair of rollers 30b sleeve and are fixed on the rotating shaft 30a, and the pair of rollers 32b sleeve and are fixed on the rotating shaft 32a. The pushing member 40 has a rotating shaft 40a and a pushing element 40b. The pushing element 40b sleeves and is fixed on the rotating shaft 40a. The card input housing 102a further has a lifting and supporting base 26 with a support plane 26a for supporting a plurality of cards 50 that are stacked and aligned in a stack. The lifting and supporting base 26 is connected to a lifting device (not shown) provided outside the card input housing 102a through the opening 24 or through other openings of the card input housing 102a, and the lifting device drives the lifting support base 26 to move up and down in the card accommodating cavity 20. In this embodiment, the lifting device drives the lifting and supporting base 26 to a predetermined position, so that the support plane 26a is substantially aligned with a gap between the roller 30b and the roller 32b, so as to allow a first card of the bottom of the plurality of cards 50 to be substantially aligned with the gap between the roller 30b and the roller 32b. In one embodiment, the lifting device is implemented by a conventional ball screw slide. The pushing element 40b is located between the lifting and supporting base 26 and the rollers 30b, 32b and is configured to press against the first card of the bottom of the plurality of cards 50. The rolling and clamping member 30 is adjacent to the main body 104a of the card slot rotating assembly 104. Each rotation of the main body 104a makes one of the plurality of card slots 104c align with the rolling and clamping member 30, so as to prepare for receiving a card transferred by the rolling and clamping member 30.

Referring to FIG. 4 and FIG. 5A, when the main body 104a is rotated to a first predetermined position by the rotating device 104b, a first card slot 104c corresponding thereto is aligned with the rolling and clamping member 30. At this time, the pushing element 40b is driven by the rotating shaft 40a to rotate in a clockwise direction, so that the first card of the bottom of the plurality of cards 50 is pushed by the pushing element 40b in a direction B toward the main body 104a of the card slot rotating assembly 104 and is moved into the gap between the roller 30b and the roller 32b. When the first card of the bottom of the plurality of cards 50 is pushed to the gap, the rotating shaft 30a drives the roller 30b to rotate in a counterclockwise direction, and the rotating shaft 32a drives the roller 32b to rotate in a clockwise direction, so that the first card is clamped by the rollers 30b and 32b and driven to be output to a first card slot 104c. When the first card enters the first card slot 104c, the pushing element 40b is configured to press against a second card of the bottom of the plurality of cards 50. Subsequently, the rotating device 104b is configured to rotate the main body 104a to a second predetermined position, so that a second card slot 104c corresponding thereto is aligned with the output end of the rolling and clamping member 30. Similarly, through the same steps described above, the second card is finally clamped by the rollers 30b and 32b and driven to be output to the second card slot 104c, and so on, until all of the plurality of cards 50 are sequentially driven and output to all of the plurality of card slots 104c. In this embodiment, the rotating shafts 30a, 32a and 40a are respectively driven by different motors or driving devices, and the motors or driving devices are controlled by control signals generated by the processor 114.

In other embodiment of the present disclosure, the lifting and supporting base 26 is replaced by a fixed support base, and the support plane on the fixed support base for supporting cards also needs to be substantially aligned with a gap between the roller 30b and the roller 32b.

In the card input housing 102a shown in FIG. 5A, the pushing element 40b is configured to press against the bottom of the plurality of cards 50 for sequentially pushing each card of the bottom of the plurality of cards 50 to the gap between the roller 30b and the roller 32b. However, the position of the pushing element 40b disclosed in the present disclosure is not limited thereto, the pushing element 40b is also disposed above the plurality of cards 50 for pressing against a first card of the top of the plurality of cards 50, so that each card of the top of the plurality of cards 50 is sequentially pushed to the gap between the roller 30b and the roller 32b, as shown in FIG. 5B.

Referring to FIG. 5B, the pushing element 40b is driven by the rotating shaft 40a to rotate in a counterclockwise direction, so that the first card of the top of the plurality of cards 50 is pushed by the pushing element 40b in a direction B toward the main body 104a of the card slot rotating assembly 104 and is moved into the gap between the roller 30b and the roller 32b. The first card of the top of the plurality of cards 50 is then clamped by the rollers 30b and 32b and driven to be output to a first card slot 104c. Similarly, when the first card enters the first card slot 104c, the pushing element 40b is configured to press against a second card of the top of the plurality of cards 50, and the second card is moved to the gap between the roller 30b and the roller 32b through the same steps as described above and is driven to be output to a second card slot 104c, and so on, until all of the plurality of cards 50 are sequentially driven and output to all of the plurality of card slots 104c.

Referring to FIG. 3 and FIG. 5B, the card input assembly 102 further has a height detector 102c, which is disposed in the card input housing 102a to detect whether a relative height of a first card of the top (i.e., the topmost card) of the plurality of cards 50 in the card accommodating cavity 20 is reduced or not. When the height detector 102c detects that the relative height of the first card of the plurality of cards 50 located in the card accommodating cavity 20 is reduced, the lifting and supporting base 26 pushes upwards, so that the pushing element 40b is able to press against the second card of the top of the plurality of cards 50. In one embodiment, the height detector 102c is implemented by an infrared sensor for measuring a distance, and the relative height is a distance between the infrared sensor and the surface of a card on the top. Specifically, when the first card has not been pushed to the main body 104a of the card slot rotating assembly 104, the infrared sensor is configured to detect a first distance between the infrared sensor and the surface of the first card and thus generate a first distance signal accordingly. Then, when the first card is pushed to the main body 104a of the card slot rotating assembly 104, the infrared sensor is configured to detect a second distance between the infrared sensor and the surface of the second card and thus generate a second distance signal accordingly. The first distance signal and the second distance signal are transmitted to a controller electrically connected to the infrared sensor, so that the controller can determine whether there is a difference between the distances indicated by the two distance signals. If the controller determines that there is a difference, it determines that the relative height of the first card of the top of the plurality of cards 50 has been reduced, which means that the first card has been pushed into a card slot 104c of the main body 104a of the card slot rotating assembly 104. At this time, the controller transmits a control signal to a control circuit of the lifting device connected to the lifting and supporting base 26 so as to control the lifting and supporting base 26 to push upwards, so that the pushing element 40b is able to press against the second card of the plurality of cards 50 for preparing to push the second card into another card slot 104c of the main body 104a of the card slot rotating assembly 104, and so on. In other embodiment, the controller is implemented by the processor 114, that is, the first distance signal and the second distance signal are transmitted to the processor 114 through the input lines 117a of the input interface 117, and the processor 114 determines whether there is a difference between the distances indicated by the two distance signals. If the processor 114 determines that there is a difference, the processor 114 generates a sixth control signal and transmits the sixth control signal to a corresponding control circuit of the lifting and supporting base 26 through the output lines 118a of the output interface 118 so as to control the lifting and supporting base 26 to push upwards, so that the pushing element 40b is able to press against the second card of the plurality of cards 50. In other embodiment, after the controller determines that there is a difference between the distances indicated by the two distance signals, a notification signal is generated and transmitted to the processor 114. After the processor 114 receives the notification signal, it generates the sixth control signal according to the notification signal and transmits the sixth control signal to the corresponding control circuit of the lifting and supporting base 26, so as to control the lifting and supporting base 26 to push upwards.

As shown in FIG. 5A and FIG. 5B, the front surfaces of the plurality of cards 50 (i.e., the surfaces containing the numbers and colors of the cards) face down, and the composite card shuffling apparatus 100 further includes an image capturing device 102d. The image capturing device 102d has a lens disposed at a bottom position of the card input housing 102a for capturing an image of each card (containing at least the number and color of the card). In this embodiment, when each card is pushed to each card slot 104c of the main body 104a of the card slot rotating assembly 104 by the pushing element 40b, the image capturing device 102d can capture the image of each card through the lens and transmit the captured image to the processor 114. The processor 114 counts the number of the plurality of cards according to the image of each card, so as to determine whether the number of the plurality of cards is correct or not. In another embodiment, the front surfaces of the plurality of cards 50 face up, and the image capturing device 102d is disposed at a top position of the card input housing 102a to capture an image of each card (containing the number and color of the card).

FIG. 5C is a partial enlarged view of the main body 104a of the card slot rotating assembly 104 shown in FIG. 2 according to one embodiment of the present disclosure. As shown in FIG. 5C, the main body 104a further has a plurality of card clamping members 105, and each card clamping member 105 is respectively disposed in each card slot 104c. Each card clamping member 105 has a V-shaped spring plate 105a and a round roller 105b, and the round roller 105b is disposed at the bottom of the V-shaped spring plate 105a. Referring to FIGS. 5A, 5B and 5C, when a card 50 is moved by the rollers 30b, 32b and outputted to the card slot 104c of FIG. 5C, the end of the card 50 enters the card slot 104c from a gap between the left side end of the V-shaped spring plate 105a and a wall surface 107 of the card slot 104c, passes through the round roller 105b, and finally passes the right side end of the V-shaped spring plate 105a, as shown in FIG. 5D. When the card 50 completely enters the card slot 104c, the two side ends of the V-shaped spring plate 105a are pressed downward by the card 50 in a direction G, so that the round roller 105b generates an upward force to push the card 50 to press against the wall surface 107. With the aforementioned card clamping member 105, the card 50 is firmly clamped in the card slot 104c and cannot fall out of the card slot 104c. In addition, since the contact area between the round roller 105b and the card 50 is quite small, the surface of the card 50 will not be damaged.

FIG. 5E is a partial enlarged view of the main body of the card slot rotating assembly shown in FIG. 2 according to another embodiment of the present disclosure. As shown in FIG. 5E, the main body 104a further has a plurality of card clamping members 205, and each card clamping member 205 is respectively disposed in each card slot 104c. Each card slot 104c is defined by a first partition 104w and a second partition 104x opposite to each other, and each card clamping member 205 has a first U-shaped spring plate 206 and a second U-shaped spring plate 207, which are respectively fixed on the first partition 104w and the second partition 104x. The first U-shaped spring plate 206 has a fixed end 206a fixed on the inner surface of the first partition 104w and a U-shaped free end 206b extending from the fixed end 206a to the entrance of the card slot 104c. The second U-shaped spring plate 207 has a fixed end 207a fixed on the inner surface of the second partition 104x and a U-shaped free end 207b extending from the fixed end 207a to the entrance of the card slot 104c. The U-shaped free end 206b of the first U-shaped spring plate 206 and the U-shaped free end 207b of the second U-shaped spring plate 207 are arranged in a back-to-back configuration, and an opening 205a is formed at the entrance of the card slot 104c for receiving a card that enters the card slot 104c. Referring to FIGS. 5A, 5B and 5E, when a card 50 is moved by the rollers 30b, 32b and outputted to the card slot 104c of FIG. 5E, the end of the card 50 enters the card slot 104c from the opening 205a formed between the U-shaped free end 206b and the U-shaped free end 207b, as shown in FIG. 5F. When the card 50 completely enters the card slot 104c, the card 50 is clamped by the U-shaped free end 206b and the U-shaped free end 207b, and then fixed in the card slot 104c. With the aforementioned card clamping member 205, the card 50 is firmly clamped in the card slot 104c and cannot fall out of the card slot 104c. In addition, since the U-shaped free end 206b and the U-shaped free end 207b contact the card 50 in a relatively small area, the surface of the card 50 will not be damaged.

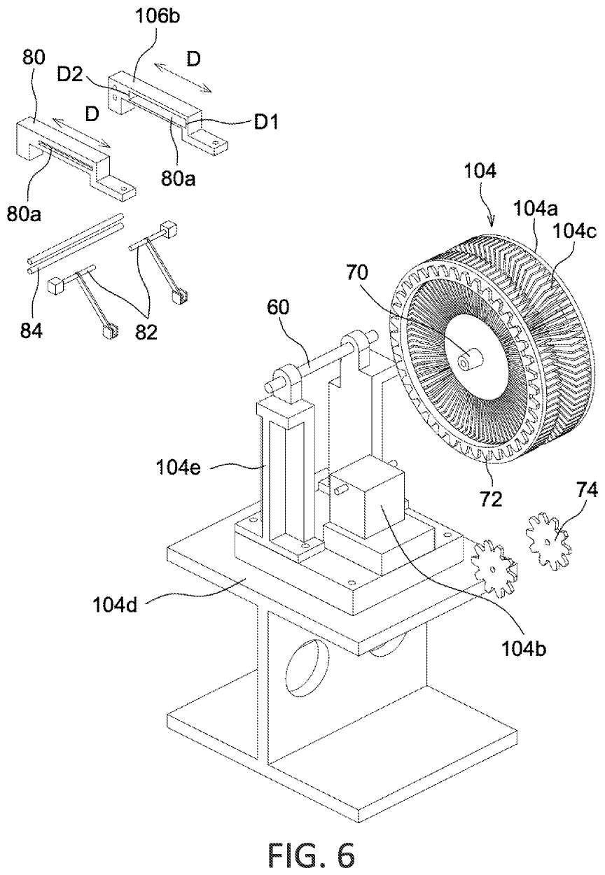

FIG. 6 is an exploded schematic diagram showing the card slot rotating assembly 104 and a portion of the card output driving device 106b of the card output assembly 106 shown as shown in FIG. 2. Referring to FIG. 2 and FIG. 6, the card slot rotating assembly 104 further has a supporting base 104d, a supporting bracket 104e and a shaft 60. The supporting bracket 104e includes a pair of supporting members separated by a distance, and is disposed on the supporting base 104d. The distance between the pair of supporting members is slightly larger than the width of the main body 104a. The shaft 60 is disposed between the pair of supporting members. The main body 104a has a shaft hole 70 for sleeving the shaft 60 disposed on the supporting bracket 104e, so that the main body 104a is configured to rotate between the pair of supporting members. The peripheries of both sides of the main body 104a are respectively provided with annual gear structures 72. In this embodiment, the rotating device 104b has a pair of gears 74 that respectively engage with the annual gear structures 72 on both sides of the main body 104a, thereby driving and rotating the main body 104a. In other embodiment, the rotating device 104b is disposed in other positions to drive the shaft 60 so as to rotate the main body 104a, and the pair of gears 74 are used as driven gears to stabilize the rotating operation of the main body 104a.

Referring to FIG. 2 and FIG. 6, the card output driving device 106b of the card output assembly 106 has a pair of slide rail members 80, a pair of pushing rods 82 and a pair of output guiding rods 84. The pair of slide rail members 80 are respectively located at both sides of the main body 104a and disposed on the pair of supporting members of the supporting bracket 104e. The pair of slide rail members 80 have a pair of elongated channels 80a defined thereon. The pair of pushing rods 82 respectively pass through the pair of elongated channels 80a and can be driven by a driving assembly (not shown) to move between a first position D1 and a second position D2 along a path D in the pair of elongated channels 80a, so as to push a card placed in each card slot 104c toward a direction of the card output housing 106a, so that the card is moved from the card slot 104c to the card output housing 106a. The pair of output guiding rods 84 define a gap for guiding the card pushed out from the card slot 104c of the main body 104a to the card output housing 106a.

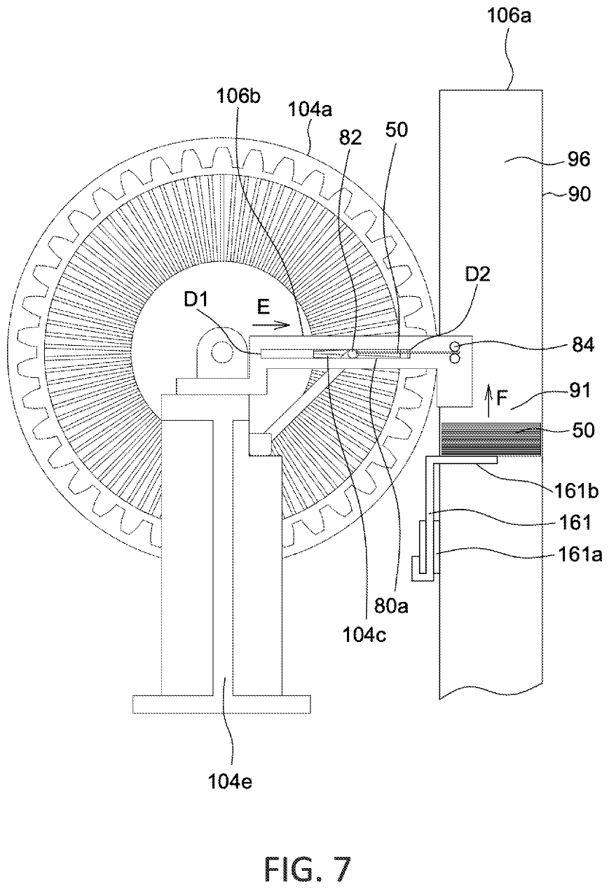

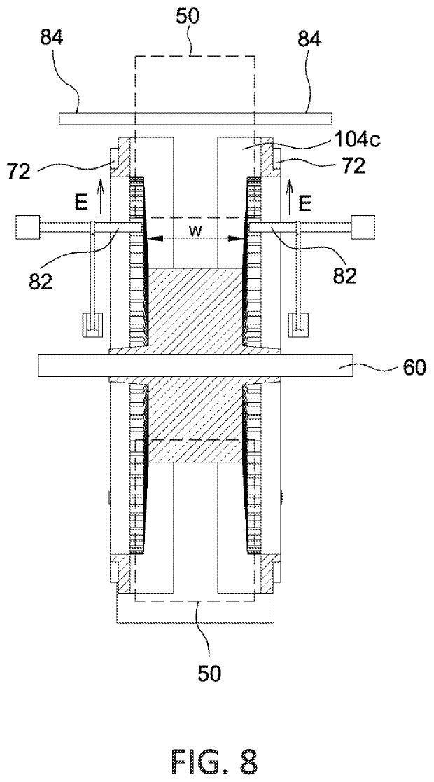

FIG. 7 is a schematic diagram showing a longitudinal cross section of portions of the card slot rotating assembly 104 and the card output assembly 106 shown in FIG. 2. FIG. 8 is a schematic diagram showing a transverse cross section of portions of the card slot rotating assembly 104 and the card output driving device 106b of the card output assembly 106 as shown in FIG. 2. As shown in FIG. 8, each card slot 104c is defined by two partitions separated by a predetermined interval. The width W between the outer sides of the partitions is smaller than the width of the card 50, so that when each card is placed in each corresponding card slot 104c, both sides of each card are exposed outside the partitions. Referring to FIGS. 6, 7 and 8, each rotation of the main body 104a makes one of the plurality of card slots 104c align with the elongated channel 80a of the pair of slide rail members 80 (that is, one of the plurality of card slots 104c is located between the pair of slide rail members 80 as shown in FIG. 7) and makes the positions of both sides of one end of the card 50 located in the card slot 104c align with the pair of pushing rods 82. As described in the above embodiment, the processor generates a third control signal to control the card output driving device 106b. In this embodiment, a driving module (not shown) of the card output driving device 106b drives the pair of pushing rods 82 to abut both sides of the end of a card 50 and to push the card 50 toward the card output housing 106a in a direction E along the pair of elongated channels 80a, so as to push out the card 50 from the card slot 104c and make the card 50 pass through the gap between the output guiding rods 84 and move into the card output housing 106a. Then, the main body 104a rotates again to make the other card slot 104c align with the elongated channel 80a of the pair of slide rail members 80, so that the driving module of the card output driving device 106b can drive the pair of pushing rods 82 again to push and move the next card 50 into the card output housing 106a, and so on.

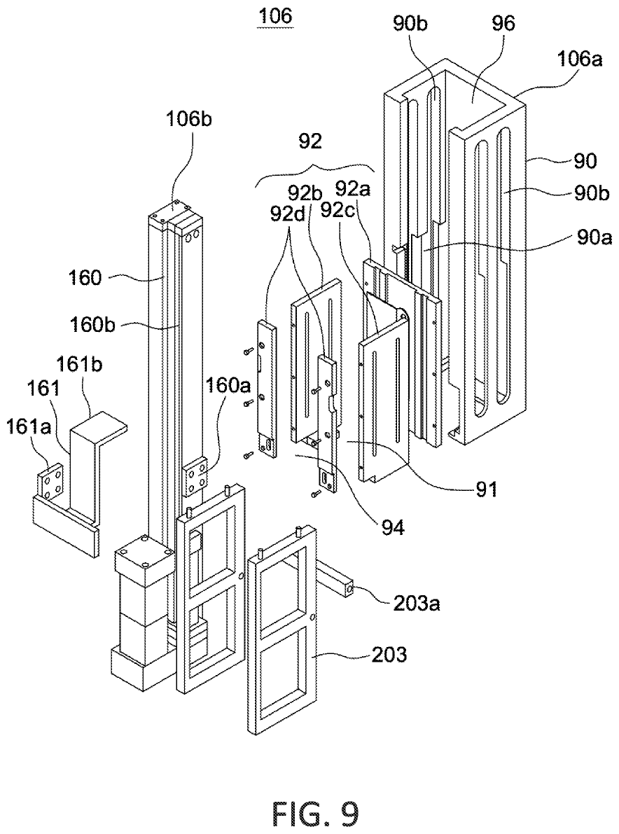

FIG. 9 is an exploded schematic diagram of a portion of the card output assembly 106 shown in FIG. 2. Referring to FIG. 7 and FIG. 9, the card output housing 106a of the card output assembly 106 has a channel housing 90 and a card accommodating housing 92. The card accommodating housing 92 is assembled by a plurality of independent plates 92a, 92b, 92c, 92d through a plurality of connecting elements (such as bolts or screws). An opening 90a is defined on one side of the lower half portion of the channel housing 90, and the opening 90a corresponds to an opening 101b of the composite card shuffling apparatus 100 (as shown in FIG. 2). The outer side of the plate 92a is provided with a handle (similar to the handle 22 of the card input housing 102a shown in FIG. 2) for an operator to pull out the card accommodating housing 92 from the opening 90a of the channel housing 90 and the opening 101b of the composite card shuffling apparatus 100, and to access the plurality of cards from the card accommodating housing 92. In addition, the card accommodating housing 92 has an opening 94 defined on the other side opposite to its handle, and the opening 94 faces and is aligned with the pair of output guiding rods 84 of the card output driving device 106b for receiving each card guided by the output guiding rods 84. The card accommodating housing 92 has a card accommodating cavity 91 defined thereinside. The length and width of the bottom of the card accommodating cavity 91 are substantially and slightly larger than the length and width of the card, so that after all the cards received from the opening 94 enter the card accommodating cavity 91, the cards can be automatically stacked and aligned in the card accommodating housing 92 as shown in FIG. 7. In addition, the channel housing 90 has a channel 96 defined thereinside, and the channel 96 communicates with the card accommodating cavity 91; and the length and width of the cross section of the channel 96 are also substantially and slightly larger than the length and width of the card.

In this embodiment, the composite card shuffling apparatus 100 further includes another supporting frame 203. The supporting frame 203 is disposed under the card output housing 106a and formed by connecting a plurality of connecting rods 203a for supporting the card output housing 106a.

Referring to FIG. 7 and FIG. 9, the transporting device 106c has a slide rail device 160 and a transporting carrier 161. The slide rail device 160 has a lifting and transporting slide plate 160a, which slides up and down along a slide rail 160b of the slide rail device 160. In one embodiment of the present disclosure, the slide rail device 160 is implemented by a conventional ball screw slide. The transporting carrier 161 has a connecting portion 161a and a supporting portion 161b. The connecting portion 161a is connected to the lifting and transporting slide plate 160a by connecting elements (such as bolts or screws). The supporting portion 161b extends from the opening 94 into the card accommodating cavity 91 for supporting the cards 50. After all of the plurality of cards 50 enter the card accommodating cavity 91 from the card slot rotating assembly 104, the processor 114 generates the fifth control signal and transmit it to the slide rail device 160, so as to control the lifting and transporting slide plate 160a to lift upwards, thereby driving the transporting carrier 161 to transport the plurality of cards 50 upwards along the channel 96 in a direction F to the card picking opening 108a. In this embodiment, the channel housing 90 has two elongated openings 90b on both sides, so that the airflow generated by transporting the plurality of cards 50 upwards along the channel 96 can be discharged through the elongated openings 90b.

In the above embodiment, the front surfaces of the plurality of cards 50 (i.e., the surfaces containing the numbers and colors of the cards) face downward in the card input housing 102a. After the cards 50 are rotated through the rotation of the main body 104a of the card slot rotating assembly 104, the front surfaces of the plurality of cards 50 will turn to face upward in the card output housing 106a. Therefore, before the plurality of cards 50 are transported to the card picking opening 108a, they must be turned over by 180 degrees before being transported from the card picking opening 108a to the card picking platform 108. Accordingly, the composite card shuffling apparatus according to the present disclosure further includes an automatic card clamping and rotating assembly for first turning the plurality of cards 50 in the card output housing 106a by 180 degrees and then transporting the plurality of turned cards 50 to the card picking opening 108a, which will be described as follows.

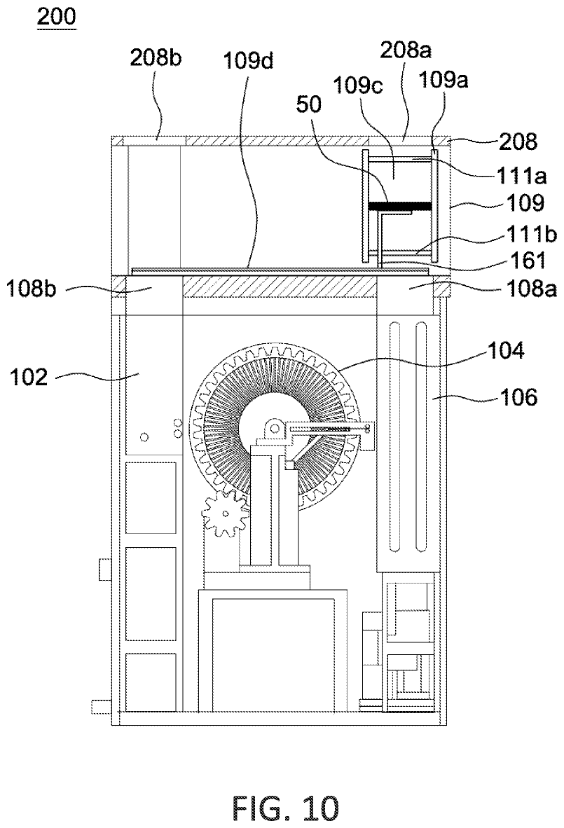

FIG. 10 is a schematic diagram of a composite card shuffling apparatus 200 according to another embodiment of the present disclosure. The composite card shuffling apparatus 200 is substantially the same as the composite card shuffling apparatus 100, and the same components are denoted by the same reference numerals, so the description thereof will not be repeated. The operation principles of the assemblies 102, 104, and 106 of the composite card shuffling apparatus 200 have been described in the embodiments mentioned above, so the description thereof will not be repeated. The main difference between the composite card shuffling apparatus 200 and the composite card shuffling apparatus 100 described in the foregoing embodiment is that the composite card shuffling apparatus 200 further includes an automatic card clamping and rotating assembly 109 and a card picking platform 208. The automatic card clamping and rotating assembly 109 is disposed above the card input assembly 102, the card slot rotating assembly 104 and the card output assembly 106 and located below the card picking platform 208, and the automatic card clamping and rotating assembly 109 is shown in cross section in FIG. 10.

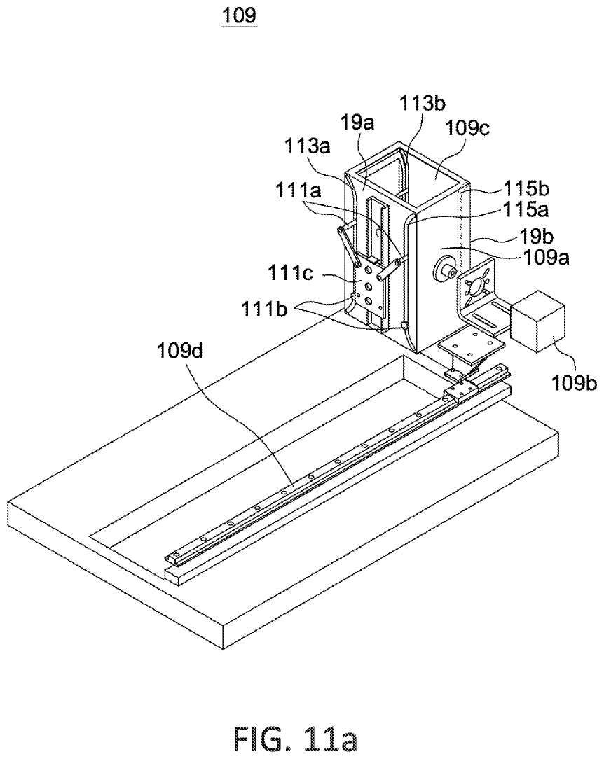

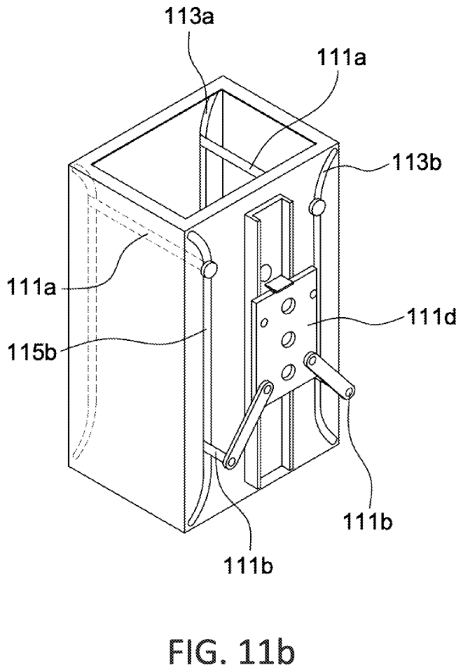

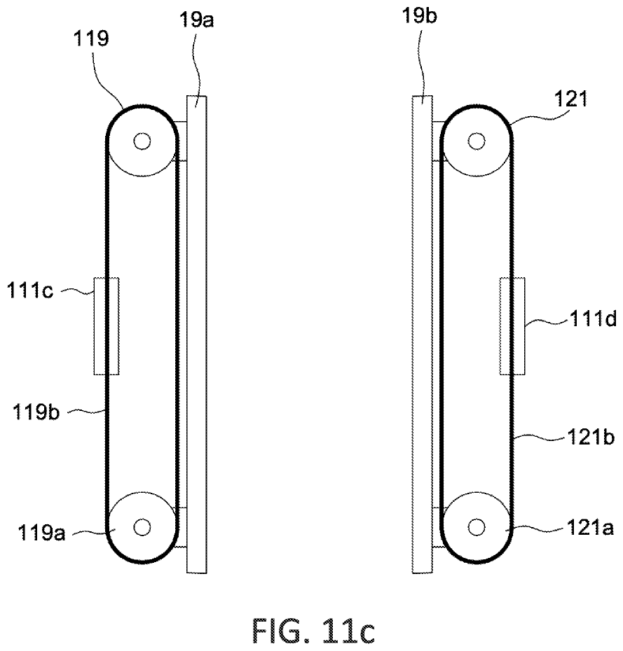

FIG. 1 la is a perspective schematic diagram of the automatic card clamping and rotating assembly shown in FIG. 10. Referring to FIG. 10 and FIG. 11a, the automatic card clamping and rotating assembly 109 has a card clamping body 109a and a rotation driving device 109b. The card clamping body 109a is connected to the rotation driving device 109b, and can be driven and rotated by 180 degrees by the rotation driving device 109b. The card clamping body 109a defines a cavity 109c. The cavity 109c and the card output housing 106a communicate with each another. The transporting carrier 161 (as shown in FIG. 7) of the transporting device 106c is further configured to transport the plurality of cards 50 in the card output housing 106a into the cavity 109c. The card clamping body 109a has a first pair of card clamping slide bars 111a and a second pair of card clamping slide bars 111b arranged thereinside, and two opposite sides 19a, 19b of the card clamping body 109a are respectively provided with a first pair of sliding slots 113a, 115a (as shown in FIG. 11a) and a second pair of sliding slots 113b, 115b (as shown in FIG. 11b). One ends of the first pair of card clamping slide bars 111a are respectively and pivotally connected to both sides of a first driving slider 111c, and the other ends of the first pair of card clamping slide bars 111a respectively pass through the first pair of sliding slots 113a, 115a, extend into the cavity 109c, and are respectively slidably coupled to the second pair of sliding slots 113b, 115b. The first driving slider 111c can be connected to a first lifting device 119 (as shown in FIG. 11c), so that the first driving slider 111c can be driven by the first lifting device 119 so as to allow the first pair of card clamping slide bars 111a to move along the upper half portion of the first pair of sliding slots 113a, 115a. In addition, referring to FIG. 11b, one ends of the second pair of card clamping slide bars 111b are respectively and pivotally connected to both sides of a second driving slider 111d, and the other ends of the second pair of card clamping slide bars 111b respectively pass through the second pair of sliding slots 113b, 115b, extend into the cavity 109c, and are respectively slidably coupled to the first pair of sliding slots 113a, 115a. The second driving slider 111d is connected to a second lifting device 121 (as shown in FIG. 11c), so that the second driving slider 111d is driven by the second lifting device 121 so as to allow the second pair of card clamping slide bars 111b to move along the lower half portion of the second pair of sliding slots 113b, 115b. In this embodiment, the sliding slot 113a and the sliding slot 113b correspond to each other and have the same shape, and the sliding slot 115a and the sliding slot 115b correspond to each other and have the same shape.

In this embodiment, as shown in FIG. 11c, the first lifting device 119 includes two gears 119a and a rolling belt 119b. The rolling belt 119b is configured to engage with the two gears 119a and moved by one of the rollers 119a driven by a driving motor (not shown). The first driving slider 111c is fixed on the outer section of the rolling belt 119b far away from the side 19a and can be moved up and down by the movement of the rolling belt 119b, thereby driving the first pair of card clamping slide bars 111a. Similarly, the second lifting device 121 includes two gears 121a and a rolling belt 121b. The rolling belt 121b is configured to engage with the two gears 121a and moved by one of the rollers 121a driven by a driving motor (not shown). The second driving slider 111d is fixed on the outer section of the rolling belt 121b far away from the side 19b and can be moved up and down by the movement of the rolling belt 121b, thereby driving the second pair of card clamping slide bars 111b.

When the plurality of cards 50 are transported into the cavity 109c, the first pair of card clamping slide bars 111a and the second pair of card clamping slide bars 111b located in the cavity 109c respectively move toward and press against the top and bottom of the plurality of cards 50 so as to clamp the plurality of cards 50 in the cavity 109c, so that the transporting carrier 161 of the transporting device 106c can leave the cavity 109c. Then, the rotation driving device 109b rotates the card clamping body 109a by 180 degrees to achieve the purpose of turning the plurality of cards 50 over. When the plurality of cards 50 are turned by 180 degrees, their front surfaces face downward. At this time, the transporting carrier 161 returns to the cavity 109c and transports the plurality of cards 50 to the outside of the cavity 109c, that is, the plurality of cards 50 can be moved to the card picking platform 208 through the card picking opening 208a of the card picking platform 208. The card picking platform 208 also has a card shuffling opening 208b for receiving the plurality of cards 50. In other embodiment, the plurality of cards 50 also is transported out of the cavity 109c by other transporting carrier (not the transporting carrier 161). In addition, the automatic card clamping and rotating assembly 109 has a slide rail 109d, and the slide rail 109d is disposed between the card picking opening 108a and the card shuffling opening 108b. The card clamping body 109a is slidably connected to the slide rail 109d, so that the card clamping body 109a can slide along the slide rail 109d to the card shuffling opening 108b and release the plurality of cards 50 to the card shuffling opening 108b, so as to restart a shuffling process.

In another embodiment, the back surfaces of the plurality of cards 50 (i.e., the surfaces without the numbers and colors of the cards) face upward in the card input housing 102a. After the cards 50 are rotated through the rotation of the main body 104a of the card slot rotating assembly 104, the front surfaces (i.e., the surfaces containing the numbers and colors of the cards) of the plurality of cards 50 will turn to face downward in the card output housing 106a. Therefore, the plurality of cards 50 are directly pushed by the transporting carrier 161 of the transporting device 106c (as shown in FIG. 7) and reach the card picking platform 108 through the card picking opening 108a.

FIG. 12 is a schematic diagram showing a cross section of portions of the card output assembly 106 and the card picking platform 108 shown in FIG. 2. As described above, the card picking platform 108 has the card picking opening 108a, the card shuffling opening 108b, the moving device 108c and the slide rail 108d. Referring to FIG. 7 and FIG. 12, the moving device 108c is located above the card picking opening 108a and has a card accommodating cavity 108e opposite to the channel 96 of the card output housing. When all the cards of the plurality of cards 50 enter the card accommodating cavity 91 from the card slot rotating assembly 104, the transport carrier 161 transports the plurality of cards 50 along the channel 96 to pass through the card picking opening 108a, so as to allow the plurality of cards 50 to enter the card accommodating cavity 108e as shown in FIG. 12. When the plurality of cards 50 enter the card accommodating cavity 108e of the moving device 108c, the upper surface of the supporting portion 161b and the upper surface of the card picking platform 108 are on the same plane. Then, the moving device 108c is configured to move the plurality of cards 50 from the card picking opening 108a to the card picking position P on the card picking platform 108 along the slide rail 108d, so that the plurality of cards 50 are taken by a robot arm or a player to perform a card game. After the card game is over, the moving device 108c is further configured to move the rest of the plurality of cards 50 from the card picking position P to the card shuffling opening 108b along the slide rail 108d, so that the plurality of cards 50 can be moved into the card input housing 102a from the card shuffling opening 108b, so as to restart a shuffling process. In other embodiment, when the plurality of cards 50 enter the card containing cavity 108e of the moving device 108c, the moving device 108c does not need to perform any movements, so that the plurality of cards 50 is directly taken by a robot arm or a player to perform a card game. After the card game is over, the moving device 108c is further configured to move the rest of the plurality of cards 50 to the card shuffling opening 108b along the slide rail 108d, so as to restart a shuffling process.

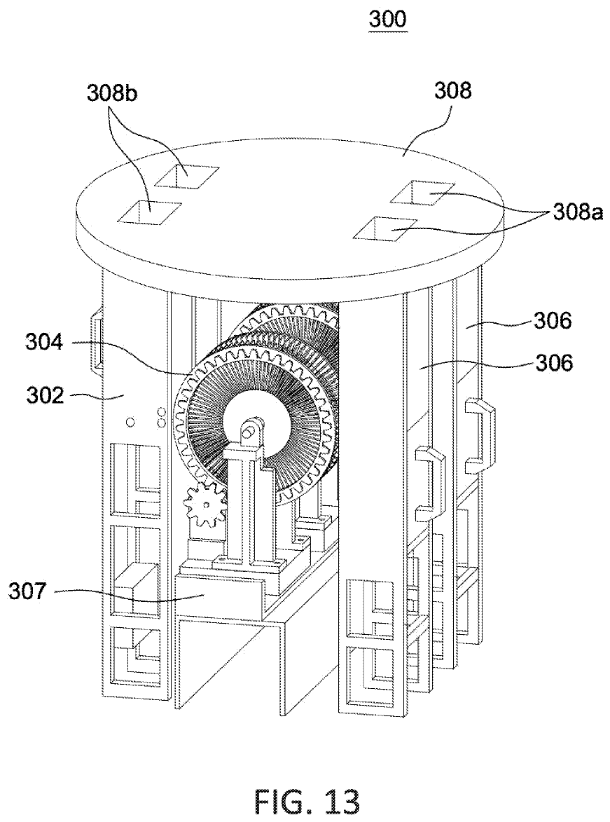

FIG. 13 is a perspective schematic diagram of a composite card shuffling apparatus 300 according to another embodiment of the present disclosure. Compared with the composite card shuffling apparatus 100, the composite card shuffling apparatus 300 is used to shuffle two sets of cards (i.e., a first and a second set of cards), wherein each set of cards includes a plurality of cards. The composite card shuffling apparatus 300 includes two card input assemblies 302 (i.e., a first and a second card input assembly 302), and two card slot rotating assemblies 304 (i.e., a first and a second card slot rotating assembly 304), two card output assemblies 306 (i.e., a first and a second card output assembly 306), a card picking platform 308 and a smart control device 310. In this embodiment, the first and the second card input assemblies 302 are disposed side by side, the first and second card slot rotating assemblies 304 are disposed side by side, and the first and second card output assemblies 306 are disposed side by side. The two card input assemblies 302 are implemented by two aforementioned card input assemblies 102, the two card slot rotating assemblies 304 are implemented by two aforementioned card slot rotating assemblies 104, and the two card output assemblies 306 are implemented by two aforementioned card output assemblies 106. The operation principles of the assemblies 302, 304, and 306 are the same as the operation principles of the assemblies 102, 104, and 106 in the above-mentioned embodiment, so the description thereof will not be repeated here. In this embodiment, the card picking platform 308 is disposed above the assemblies 302, 304, and 306 and has two card picking openings 308a for receiving the two sets of cards that have been shuffled, and two card shuffling openings 308b for recycling the two sets of cards after the card game is over so as to start the next shuffling process. The control operations of the smart control device 310 and the smart control device 110 are substantially the same, and therefore, the description thereof will not be repeated here. In this embodiment, the smart control device 310 also controls the first and second card input assemblies 302 to operate synchronously, controls the first and second card slot rotating assemblies 304 to operate synchronously, and controls the first and second card output assemblies 306 to operate synchronously, so that the two sets of cards are shuffled at the same time, and the shuffling process can be completed at the same time.

In other embodiment, the composite card shuffling apparatus 300 includes two card input assemblies 302 (i.e., a first and a second card input assembly 302) and two card output assemblies 306 (i.e., a first and a second card output assembly 306) but include only one card slot rotating assembly 304. In this embodiment, the bottom 307 (as shown in FIG. 13) of the card slot rotating assembly 304 is provided with a sliding assembly (not shown) configured to slide the card slot rotating assembly 304 to a position between the first card input assembly 302 and the first card output assembly 306 or between the second card input assembly 302 and the second card output assembly 306, so as to achieve the purpose of sharing the card slot rotating assembly 304. The above-mentioned sliding assembly is disposed on the bottom 307 of the card slot rotating assembly 304 and implemented by any conventional slide rail mechanism, and the description thereof will not be repeated here.

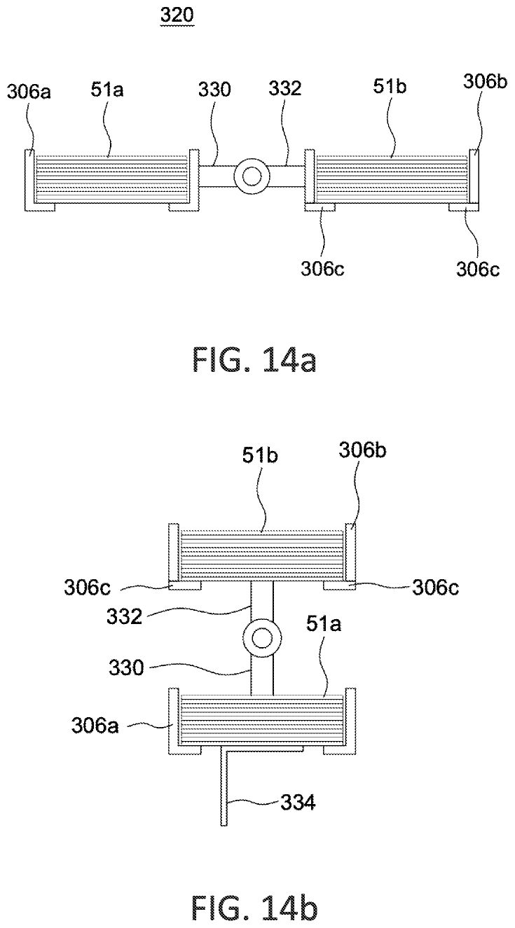

In another embodiment, the first and second card output assemblies 306 of the composite card shuffling apparatus 300 of FIG. 13 are replaced by a rotary alignment assembly 320 (as shown in FIG. 14a) for stacking the two sets of shuffled cards into the same stack, so that the cards can be taken out through the same card picking opening. Referring to FIGS. 13, 14a and 14b, the rotary alignment assembly 320 has a first card output housing 306a for receiving the first set of cards 51a outputted from a first main body of the first card slot rotating assembly 304. The rotary alignment assembly 320 has a second card output housing 306b for receiving the second set of cards 5 lb outputted from a second main body of the second card slot rotating assembly 304. The rotary alignment assembly 320 further has a first rotating arm 330, a second rotating arm 332 and a transporting carrier 334. The first rotating arm 330 is connected to the back plate of the first card output housing 306a, and the second rotating arm 332 is connected to the back plate of the second card output housing 306b. After the first set of cards 51a all enter the first card output housing 306a, and the second set of cards 51b all enter the second card output housing 306b, the first rotating arm 330 and the second rotating arm 332 can respectively rotate counterclockwise (or clockwise) by 90 degrees, so that the first card output housing 306a and the second card output housing 306b are aligned along a straight line as shown in FIG. 14b. After the two card output housings 306a and 306b are aligned, the transporting carrier 334 presses against the bottom of the first set of cards 51a from an opening below the first card output housing 306a and pushes upward along the straight line, so that the top of the first set of cards 51a reaches supporting plates 306c at the bottom of the second card output housing 306b. In this embodiment, the two supporting plates 306c are designed to be movable. When the top of the first set of cards 51a reaches the supporting plates 306c at the bottom of the second card output housing 306b, the two supporting plates 306c move toward both sides respectively, so that the first set of cards 51a is stacked on the bottom of the second set of cards 51b. Then, the two stacked sets of cards 51a, 51b continue to be pushed up by the transporting carrier 334 to a card picking opening, so as to achieve the purpose of stacking the two sets of cards 51a, 51b.

Although the present disclosure has been disclosed in the above embodiments, those embodiments are not intended to limit the present disclosure. Anyone with ordinary knowledge in the relevant technical field can make some changes and modifications without departing from the spirit and scope of the present disclosure, so the scope of protection of the present disclosure shall be determined by the scope defined by the pending claims.

What is claimed is:

1. A composite card shuffling apparatus for shuffling a plurality of cards, comprising:
a card input assembly having a card input housing and a card input guiding device, wherein the card input housing is configured to accommodate the plurality of cards, and the card input guiding device is configured to sequentially move out the plurality of cards from the card input housing;
a card slot rotating assembly having a main body and a rotating device, wherein the main body has a plurality of card slots defined thereon, and the rotating device is connected to the main body for rotating the main body, so that the plurality of card slots of the main body respectively receive the plurality of cards sequentially moved out from the card input housing;
a card output assembly having a card output housing, a card output driving device and a transporting device, wherein the card output driving device is configured to respectively move each of the plurality of cards from the plurality of card slots into the card output housing, and the transporting device is configured to transport the plurality of cards inside the card output housing to the outside of the card output housing; and
a card picking platform having a card picking opening, wherein the card picking opening communicates with the card output housing for receiving the plurality of cards transported by the transporting device.

2. The composite card shuffling apparatus of claim 1, further comprising a control circuit including a processor and a storage unit, wherein the storage unit is configured to store a random number generating program, and the processor is electrically connected to the storage unit and configured to execute the random number generating program for generating a plurality of random numbers, and wherein the rotating device is configured to intermittently and alternately rotate the main body in a first direction and a second direction opposite to the first direction according to the plurality of random numbers.

3. The composite card shuffling apparatus of claim 2, wherein when the plurality of cards are all moved from the card input housing to the card output housing through the card slot rotating assembly, the processor is configured to generate a control signal to stop the rotating device from rotating.

4. The composite card shuffling apparatus of claim 1, wherein the card input guiding device has a rolling and clamping member and a pushing member, the rolling and clamping member has two rotating shafts, and the pushing member is configured to press against a first card of the plurality of cards and push the first card into a gap between the two rotating shafts, so that the first card is driven and output to a first card slot of the plurality of card slots through rotation of the two rotating shafts.

5. The composite card shuffling apparatus of claim 4, wherein the pushing member is configured to press against the first card of a bottom of the plurality of cards.

6. The composite card shuffling apparatus of claim 4, wherein the pushing member is configured to press against the first card of a top of the plurality of cards, and the card input housing has a lifting and supporting base for supporting the plurality of cards; and wherein when the first card enters the first card slot, the lifting and supporting base is configured to push the plurality of cards upwards, so that the pushing member is able to press against a second card of the plurality of cards.

7. The composite card shuffling apparatus of claim 6, wherein the card input assembly further has a height detector disposed in the card input housing for detecting whether a relative height of the first card is reduced; and when the height detector detects that the relative height of the first card is reduced, the lifting and supporting base pushes upwards, so that the pushing member presses against the second card.

8. The composite card shuffling apparatus of claim 2, further comprising an image capturing device, wherein the image capturing device has a lens disposed in the card input housing for capturing an image of each card of the plurality of cards, and wherein the processor is further configured to count the number of the plurality of cards according to the image of each card.

9. The composite card shuffling apparatus of claim 1, wherein the card slot rotating assembly is disposed between the card input assembly and the card output assembly, and the card picking platform is disposed above the card input assembly, the card slot rotating assembly and the card output assembly.

10. The composite card shuffling apparatus of claim 1, wherein the main body further has a plurality of card clamping members, and each of the card clamping members is disposed in each card slot and has a first U-shaped spring plate and a second U-shaped spring plate; and
wherein the first U-shaped spring plate has a first U-shaped free end, the second U-shaped spring plate has a second U-shaped free end, and the first U-shaped free end and the second U-shaped free end are opposite to each other for clamping one of the plurality of cards.

11. The composite card shuffling apparatus of claim 1, wherein the main body further has a plurality of card clamping members, each of the card clamping members is disposed in each card slot and has a V-shaped spring plate and a round roller, and the round roller is disposed at the bottom of the V-shaped spring plate for pushing one of the plurality of cards to press against a wall surface of a card slot corresponding to the round roller.

12. The composite card shuffling apparatus of claim 1, wherein the card slot rotating assembly further comprises a supporting bracket and a shaft, the supporting bracket includes a pair of supporting members, and the shaft is disposed between the pair of supporting members; and wherein the main body has a shaft hole configured to sleeve the shaft, so that the main body is configured to rotate between the pair of supporting members.

13. The composite card shuffling apparatus of claim 12, wherein the card output driving device has a pair of slide rail members and a pair of pushing rods, the pair of slide rail members are respectively located at both sides of the main body and disposed on the pair of supporting members, and the pair of slide rail members have a pair of channels defined thereon; wherein the pair of pushing rods respectively pass through the pair of channels; and wherein when one of the plurality of card slots is aligned with the pair of channels, the pair of pushing rods are configured to push along the pair of channels a card located in the card slot aligned with the channels, so that the card is pushed out from the card slot.

14. The composite card shuffling apparatus of claim 1, wherein the transporting device has a slide rail device and a transporting carrier, the slide rail device has a lifting and transporting slide plate, and the transporting carrier is connected to the lifting and transporting slide plate for supporting the plurality of cards; and wherein after the plurality of cards are moved to the card output housing, the lifting and transporting slide plate is configured to lift upwards, thereby driving the transporting carrier to transport the plurality of cards to the card picking opening.

15. The composite card shuffling apparatus of claim 1, further comprising a moving device, wherein the card picking platform further has a card shuffling opening communicating with the card input housing, and the moving device is further configured to move at least one of the plurality of cards from the card picking opening to the card shuffling opening, so that the at least one of the plurality of cards is moved into the card input housing from the card shuffling opening.

16. The composite card shuffling apparatus of claim 1, further comprising an automatic card clamping and rotating assembly having a card clamping body and a rotation driving device, wherein the card clamping body defines a cavity communicating with the card output housing, and the transporting device is further configured to transport the plurality of cards in the card output housing into the cavity; and wherein when the plurality of cards are transported into the cavity, the rotation driving device is configured to rotate the card clamping body by 180 degrees.

17. The composite card shuffling apparatus of claim 16, wherein the card clamping body has at least one card clamping member disposed thereinside; and wherein when the plurality of cards are transported into the cavity, the at least one card clamping member is configured to clamp the plurality of cards.

18. A composite card shuffling apparatus for shuffling a first set of cards and a second set of cards, comprising:
a first card input assembly having a first card input housing and a first card input guiding device, wherein the first card input housing is configured to accommodate the first set of cards, and the first card input guiding device is configured to sequentially move out the first set of cards from the first card input housing;
a first card slot rotating assembly having a first main body and a first rotating device, wherein the first main body has a plurality of card slots defined thereon, and the first rotating device is connected to the first main body for rotating the first main body, so that the plurality of card slots of the first main body respectively receive the first set of cards sequentially moved out from the first card input housing;
a first card output assembly having a first card output housing and a first card output driving device, wherein the first card output driving device is configured to respectively move each of the first set of cards from the plurality of card slots into the first card output housing;
a second card input assembly disposed with the first card input assembly side by side and having a second card input housing and a second card input guiding device, wherein the second card input housing is configured to accommodate the second set of cards, and the second card input guiding device is configured to sequentially move out the second set of cards from the second card input housing;
a second card slot rotating assembly disposed with the first card slot rotating assembly side by side and having a second main body and a second rotating device, wherein the second main body has a plurality of card slots defined thereon, and the second rotating device is connected to the second main body for rotating the second main body, so that the plurality of card slots of the second main body respectively receive the second set of cards sequentially moved out from the second card input housing;
a second card output assembly disposed with the first card output assembly side by side and having a second card output housing and a second card output driving device, wherein the second card output driving device is configured to respectively move each of the second set of cards from the plurality of card slots into the second card output housing; and
a rotary alignment assembly having a first rotating arm, a second rotating arm and a transporting carrier, wherein after the first set of cards enter the first card output housing, and the second set of cards enter the second card output housing, the first rotating arm and the second rotating arm respectively rotate by a predetermined degrees, so that the first card output housing and the second card output housing are aligned along a straight line; and wherein after the first card output housing and the second card output housing are aligned, the transporting carrier pushes upward along the straight line from a position below a bottom of the first and the second card output housings, so that the first set of cards and the second set of cards are stacked and pushed to a card picking opening.

19. A composite card shuffling apparatus for shuffling a first set of cards and a second set of cards, comprising:
a first card input assembly having a first card input housing and a first card input guiding device, wherein the first card input housing is configured to accommodate the first set of cards, and the first card input guiding device is configured to sequentially move out each of the first set of cards from the first card input housing;
a second card input assembly disposed with the first card input assembly side by side and having a second card input housing and a second card input guiding device, wherein the second card input housing is configured to accommodate the second set of cards, and the second card input guiding device is configured to sequentially move out each of the second set of cards from the second card input housing;
a card slot rotating assembly having a main body and a rotating device, wherein the main body has a plurality of card slots defined thereon, and the rotating device is connected to the main body for rotating the main body, so that the plurality of card slots of the main body respectively receive the first set of cards sequentially moved out from the first card input housing or receive the second set of cards sequentially moved out from the second card input housing;
a first card output assembly having a first card output housing and a first card output driving device, wherein the first card output driving device is configured to respectively move each of the first set of cards from the plurality of card slots into the first card output housing;
a second card output assembly disposed with the first card output assembly side by side and having a second card output housing and a second card output driving device, wherein the second card output driving device is configured to respectively move each of the second set of cards from the plurality of card slots into the second card output housing; and
a sliding assembly disposed at a bottom of the card slot rotating assembly, wherein the sliding assembly is configured to slide the card slot rotating assembly to a position between the first card input assembly and the first card output assembly or between the second card input assembly and the second card output assembly.
